(19) United States
(12) Patent Application Publication
(10) Pub. No.: US 2009/0157823 A1
(43) Pub. Date: Jun. 18, 2009

(54) APPARATUS AND METHOD FOR FACILITATING SECURE EMAIL SERVICES USING MULTIPLE PROTOCOLS

(75) Inventor: William F. Price, III, Los Altos, CA (US)

Correspondence Address: COOLEY GODWARD KRONISH LLP;ATTN: Patent Group, Suite 1100, 777 - 6th Street, NW, Washington, DC, 20001, US

(73) Assignee: PGP CORPORATION, Palo Alto, CA (US)

(21) Appl. No.: 11/955,750

(22) Filed: Dec. 13, 2007

(51) Int. Cl. G06F 15/16; G06F 21/00

(52) U.S. Cl. 709/206; 726/1

(57) ABSTRACT

A computer readable storage medium includes executable instructions to identify when a security policy cannot be applied by a supported secure email machine to a received email message and thus the email message is routed to an auxiliary secure email machine. Secure email policies are applied to the email message at the auxiliary secure email machine. The email message is then routed from the auxiliary secure email machine to the supported secure email machine.

### BRIEF DESCRIPTION OF THE INVENTION

This invention relates generally to secure network communications. More particularly, this invention relates to a technique for supporting secure email services using multiple protocols, including proprietary and open protocols.

### BACKGROUND OF THE INVENTION

FIG. 1 illustrates a prior art system 100 for facilitating secure email services (e.g., encryption and decryption) using an email server that utilizes a supported protocol. The system 100 includes a client machine 102 that communicates with an email server 106 through a secure email policy enforcement server 104. The secure email policy enforcement server 104 supports the protocol used by the email server 106 and therefore is referred to as a supported secure email machine. The secure email policy enforcement server 104 can be positioned between the email server 106 and the client 102 and can offer secure email policy enforcement services to the client transparently. The email server 106 receives and transmits encrypted messages via the Internet 108. This prior art system is disclosed in a set of pending U.S. patent applications owned by PGP Corporation, Palo Alto, Calif., the assignee of the present invention. These applications include: System and Method for Secure and Transparent Electronic Communication, Ser. No. 10/462,775; System and Method For Dynamic Security Operations, Serial Number 10/462,607; and System and Method for Secure Electronic Communication in a Partially Keyless Environment, Serial Number 10/462,618. The content of these applications is incorporated herein by reference.

The configuration of FIG. 1 is not available if the protocol used by the email server 106 is unsupported (e.g., it is proprietary or otherwise not supported by the secure email policy enforcement server 104). In this case, the secure email policy enforcement server 104 cannot be positioned between the email server 106 and the client 102. Accordingly, the secure email policy enforcement server 104 cannot process email between the email server 106 and the client 102. That is, the secure email policy enforcement server 104 cannot operate to provide secure email policy enforcement services.

In view of this problem, it would be desirable to provide a technique that allows a secure email policy enforcement server to operate with an email server using an unsupported protocol. More particularly, it would be desirable to provide a technique to facilitate encryption and decryption operations in connection with an email server using an unsupported protocol.

### SUMMARY OF THE INVENTION

The invention includes a computer readable storage medium with executable instructions to identify when a security policy cannot be applied by a supported secure email machine to a received email message and thus the email message is routed to an auxiliary secure email machine. Secure email policies are applied to the email message at the auxiliary secure email machine. The email message is then routed from the auxiliary secure email machine to the supported secure email machine.

The invention also includes a computer readable storage medium with executable instructions to determine that a security policy cannot be applied by a supported secure email machine to a generated email message and thus the email message is routed to an auxiliary secure email machine. Secure email policies are applied to the email message at the auxiliary secure email machine. The email message is directed from the auxiliary secure email machine to the supported secure email machine for routing to a recipient.

### BRIEF DESCRIPTION OF THE FIGURES

The invention is more fully appreciated in connection with the following detailed description taken in conjunction with the accompanying drawings, in which:

FIG. 1 illustrates a prior art system for supporting secure email policy enforcement operations.

FIG. 2 illustrates a network, configured in accordance with an embodiment of the invention, for facilitating secure email policies in connection with an email server using an unsupported protocol.

FIG. 3 illustrates processing operations associated with the processing of an incoming message according to an embodiment of the invention.

FIG. 4 illustrates processing operations associated with the processing of an outgoing message according to an embodiment of the invention

Like reference numerals refer to corresponding parts throughout the several views of the drawings.

### DETAILED DESCRIPTION OF THE INVENTION

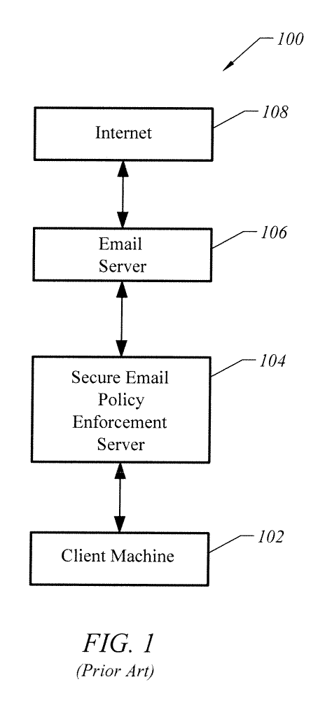

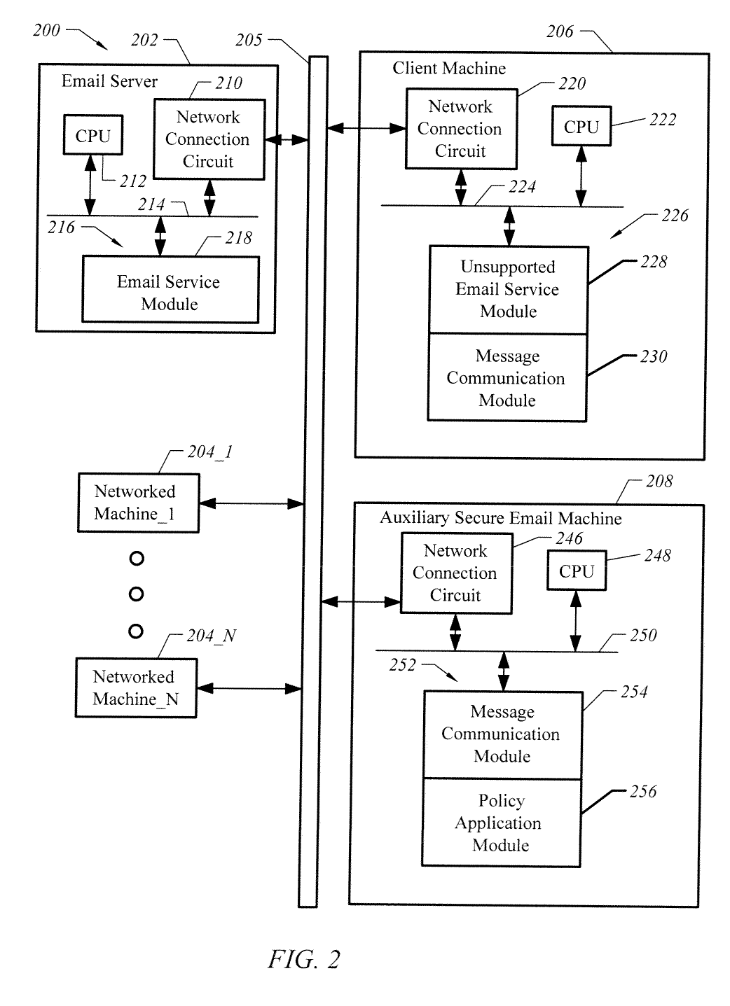

FIG. 2 illustrates a network 200 configured in accordance with an embodiment of the invention. The network 200 includes an email server 202. The email server 202 utilizes a supported email service; that is, the email service is supported with respect to another machine that facilitates secure email services. The network 200 also includes set of networked machines 204_1 through 204_N that are used to route email messages. The networked machines may be email servers operating as supported or unsupported secure email machines. In the case of a supported secure email machine, standard secure email policy enforcement may be utilized in accordance with the prior art, such as the prior art configuration of FIG. 1.

The networked machines 204 may also be any type of client machine, including, for example, a personal computer, a personal digital assistant, and the like. The email server 202 and the networked machines 204 are linked by a transmission infrastructure 205, which may be any wired or wireless transmission medium.

Also connected to the transmission infrastructure 205 is a client machine 206, which is configured with software to implement operations of the invention. An auxiliary secure email machine 208, configured with software to implement operations of the invention, is also connected to the transmission infrastructure 205. The auxiliary secure email machine 208 facilitates the encryption and decryption of email messages. That is, the machine 208 participates in at least a portion of the process of encrypting or decrypting email messages associated with the client 206. Thus, the auxiliary secure email machine 208 operates as a secure email support facility for an unsupported protocol (i.e., a protocol that is not used between the email server 202 and a supported secure email machine 204). The auxiliary secure email machine 208 may also implement digital signature policies, as discussed below.

The email server 202 includes standard components, such as a network connection circuit 210, which is linked to a CPU 212 over a bus 214. A memory 216 is also connected to the bus 214. The memory 216 stores an email service module 218 to implement standard email operations.

The client machine 206 also includes standard components, such as a network connection circuit 220, a CPU 2 and a bus 224. A memory 226 is also connected to the bus 224. The memory 226 stores a set of executable instructions used to implement operations of the invention. The executable instructions include an unsupported email service module 228. The memory 230 also stores executable instructions in the form of a message communication module 230. This module, implemented in accordance with an embodiment of the invention, includes executable instructions to facilitate the routing of messages to the auxiliary secure email machine 208. In one embodiment, these communications are implemented using an open communication protocol, such as the Simple Object Access Protocol (SOAP). SOAP is a protocol specification for invoking methods. SOAP codifies the existing practice of using XML and HTTP as a method invocation mechanism. The SOAP specification also mandates an XML vocabulary that is used for representing method parameters, return values, and exceptions.

The auxiliary secure email machine 208 includes standard components, such as a network connection circuit 246, a CPU 248, and a bus 250. A memory 252 is also connected to the bus 250. The memory 252 stores executable instructions used to implement operations of the invention. In this embodiment, the memory stores a message communication module 254. The message communication module 254 includes executable instructions to communicate with the client machine 206. In one embodiment, these communications are implemented using an open communication protocol, such as the Simple Object Access Protocol (SOAP). The memory 252 also stores a policy application module 256. This module includes executable instructions to implement secure email policies (cryptographic policies), such as encryption, decryption, signatures, routing restrictions, and the like.

Various modules for implementing operations of the invention have now been introduced. It should be appreciated that these modules are exemplary. The operations of the invention may be implemented in any number of modules or configurations. Similarly, the network location at which these modules execute is insignificant. It is the operations of the invention, regardless of how they are implemented or where they are implement that are significant.

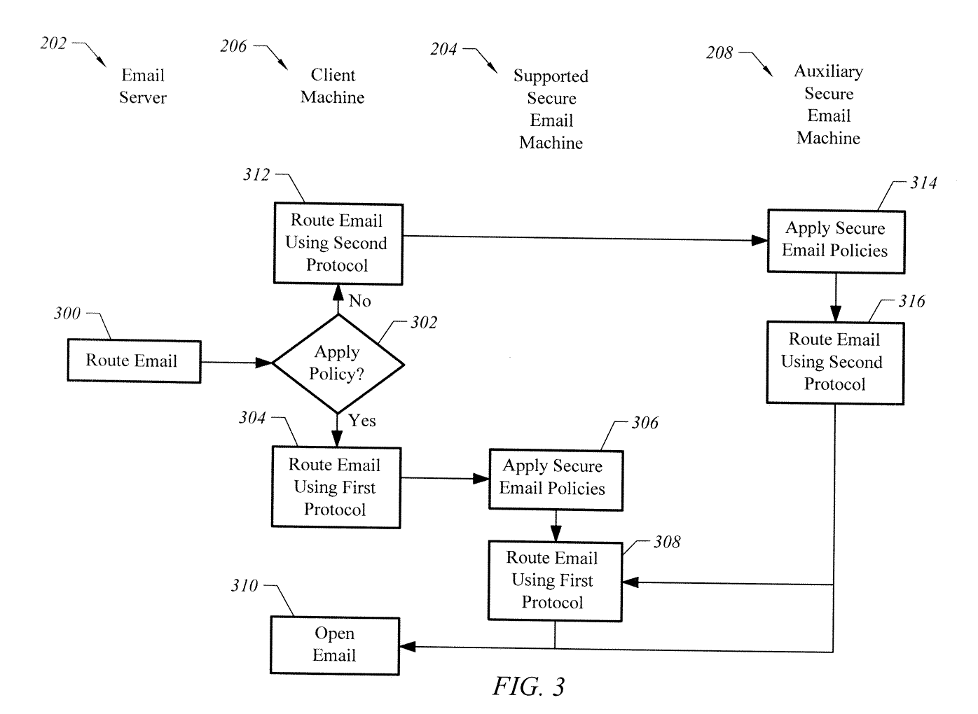

FIG. 3 illustrates processing operations associated with an embodiment of the invention. The figure illustrates various locations for performing various operations of the invention. In particular, the figure includes an email server 202 and an operation underneath the email server that may be performed by the email server. Similarly the figure illustrates a client machine 206 and associated operations performed in accordance with an embodiment of the invention. The figure also illustrates a supported secure email machine 204 and an auxiliary secure email machine 208. The supported secure email machine 204 implements operations associated with the prior art, while the auxiliary secure email machine 208 implements operations associated with an embodiment of the invention.

The first processing operation shown in FIG. 3 is for the email server 202 to route an incoming email message (300). The client machine determines whether the supported secure email machine can apply a security policy to the email (302). If the security policy can be applied (302—YES), then the email is routed using a first protocol (304) that is common to the email server and the supported secure email machine 204. The supported secure email machine 204 applies email policies (e.g., decryption) to the email (306). The email is then returned to the client using the first protocol (308). The client may then open the secure email (310). These operations are consistent with the prior art processing of FIG. 1. However, in the approach of FIG. 1, it is presumed that the protocols are common and therefore the policy check of block 302 is not used.

If the secure policy cannot be applied (302—NO), then the email is sent to the auxiliary secure email machine 208 using a second protocol (312). This operation may be implemented with the message communication module 230. In one embodiment, the message communication module 230 includes executable instructions to encapsulate the message in an open communication protocol, such as a SOAP communication. The message communication module 254 of the auxiliary secure email machine 208 receives the open protocol communication and passes it to the policy application module 256, which applies secure email policies (314) to the message. For example, if the client machine 206 does not have a private key, the policy application module 256 requests the private key from a network resource. The policy application module 256 then decrypts the message using the key. If the message is also signed, the policy application module 256 requests the sender's public key to verify the signature. Upon receipt of the public key, the policy application module 256 verifies the signature.

The decrypted message and the verified signature, if applicable, is then supplied to the message communication module 254, which routes the message to the supported secure email machine 204, which routes the email to the client 308. In one embodiment, the auxiliary secure email machine 208 routes the email directly to the client machine 206 using an open protocol (e.g., a second protocol) (316). The message communication module 230 of the client machine 206 receives the message. Executable instructions associated with the module strip the open protocol package to render the original message. The client machine can then open the original message (310).

The message communication module 230 may use any number of techniques to route the incoming messages to the auxiliary secure email machine 208. As previously indicated, an open protocol, such as the SOAP protocol may be advantageously used. However, other protocols, including proprietary protocols may be used for the communications between the client machine 206 and the auxiliary secure email machine 208, although such implementations are more cumbersome.

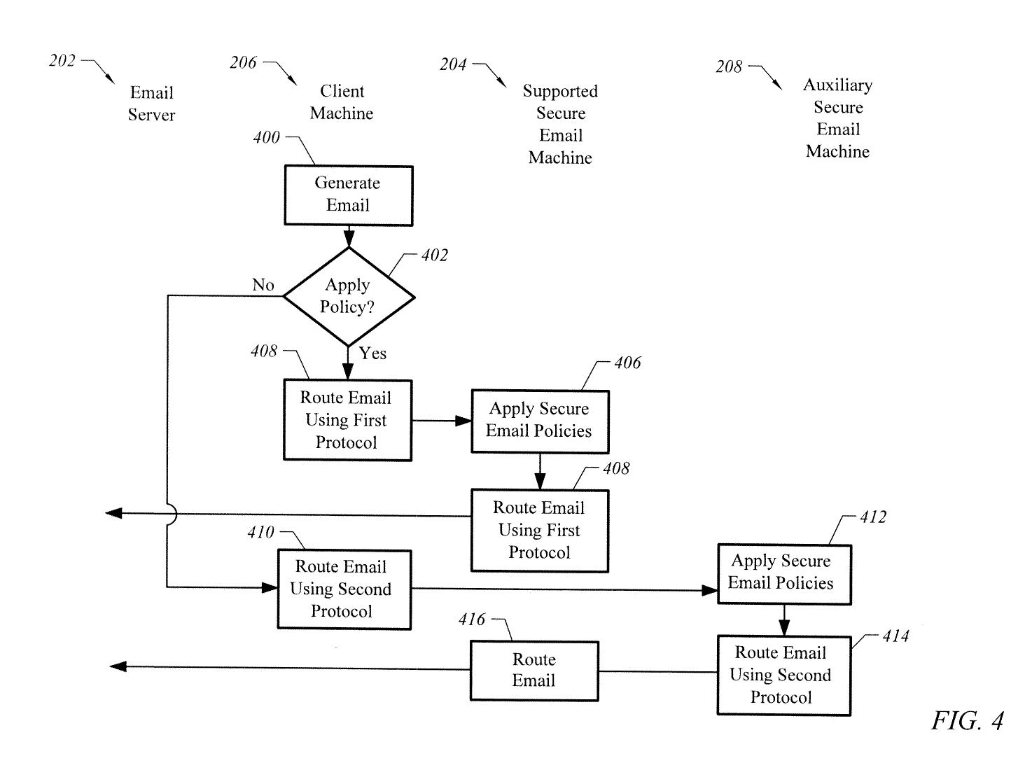

FIG. 4 illustrates processing operations associated with the processing of an outgoing message originating on a client machine 206. The first operation of FIG. 4 is to generate an email message (400). The client machine then determines whether a security policy can be applied to the message (402). If so (402—YES), then the email is routed to the supported secure email machine (404) using the common protocol (e.g., a first protocol) between the client machine 206, the email server 202 and the supported secure email machine 204. The supported secure email machine 204 then applies secure email policies (e.g., encryption) to the message (406). The email is then routed from the supported secure email machine to the email server 202 using the first protocol (408).

If the protocol is not supported (402—NO), then the message is routed to the auxiliary secure email machine 208 using a second protocol (410). An open protocol, such as the SOAP protocol, is preferably used to implement this operation. That is, the message communication module 230 utilizes executable instructions to encapsulate the email message as a SOAP message.

The message communication module 254 of the auxiliary secure email machine 208 receives the message and passes it to the policy application module 256. The policy application module 256 then applies secure email policies to the email (412). For example, the policy application module 256 includes executable instructions to request the public key for the message recipient. The policy application module 256 then encrypts the message to the recipient's public key. The policy application module 256 then sends the email using the second protocol (414). For example, the email is sent to the supported secure email machine, which then routes the email (416).

In an alternate embodiment of the invention, the determination of whether a protocol is supported is performed at the email server 202. Similarly, routing to the supported secure email machine 204 or the auxiliary secure email machine 28 is initiated from the email server 202.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium, comprising executable instructions to:
identify when a security policy cannot be applied by a supported secure email machine to a received email message and in response thereto, route the email message to an auxiliary secure email machine;
apply secure email policies to the email message at the auxiliary secure email machine; and
route the email message from the auxiliary secure email machine to the supported secure email machine.

2. The computer readable storage medium of claim 1 wherein the executable instructions to route the email message include executable instructions to route the email message using an open communication protocol.

3. The computer readable storage medium of claim 2 wherein the executable instructions to route the email message include executable instructions to route the email message using the Simple Object Access Protocol.

4. The computer readable storage medium of claim 1 wherein the executable instructions to apply secure email policies to the email message include executable instructions to apply a cryptographic policy to the email message.

5. The computer readable storage medium of claim 1 wherein the executable instructions to apply secure email policies to the email message include executable instructions to apply a signature policy to the email message.

6. A computer readable storage medium, comprising executable instructions to:
determine that a security policy cannot be applied by a supported secure email machine to a generated email message and in response thereto, route the email message to an auxiliary secure email machine;
apply secure email policies to the email message at the auxiliary secure email machine, and
direct the email message from the auxiliary secure email machine to the supported secure email machine for routing to a recipient.

7. The computer readable storage medium of claim 6 wherein the executable instructions to route the email message include executable instructions to route the email message using an open communication protocol.

8. The computer readable storage medium of claim 7 wherein the executable instructions to route the email message include executable instructions to route the email message using the Simple Object Access Protocol.

9. The computer readable storage medium of claim 6 wherein the executable instructions to apply secure email policies to the email message include executable instructions to apply an encryption policy to the email message.

10. The computer readable storage medium of claim 6 wherein the executable instructions to apply secure email policies to the email message include executable instructions to apply a signature policy to the email message.
